(19) United States
(12) Patent Application Publication
(10) Pub. No.: US 2002/0094086 A1
(43) Pub. Date: Jul. 18, 2002

(54) Device having a control unit and a nonvolatile memory

(76) Inventors: Norbert Grassmann, Regensburg (DE); Michael Wagner, Regensburg (DE)

Correspondence Address: LERNER AND GREENBERG, P.A., POST OFFICE BOX 2480, HOLLYWOOD, FL, 33022-2480, US

(21) Appl. No.: 10/053,064

(22) Filed: Jan. 17, 2002

(30) Foreign Application Priority Data
Jan. 17, 2001 (DE) 101 01 972.6

(51) Int. Cl. G06F 12/00; G06F 12/14

(52) U.S. Cl. 380/264

(57) ABSTRACT

The device has a control unit with memory devices and a nonvolatile memory connected to the control unit for data exchange purposes. Data are stored in encrypted form in the nonvolatile memory. The key or keys for encrypting the data are stored in the memory devices or are generated by an algorithm executed in the control unit. An address pointer that indicates the address of a valid key in the control unit is stored in the nonvolatile memory and/or in a volatile memory of the control unit.

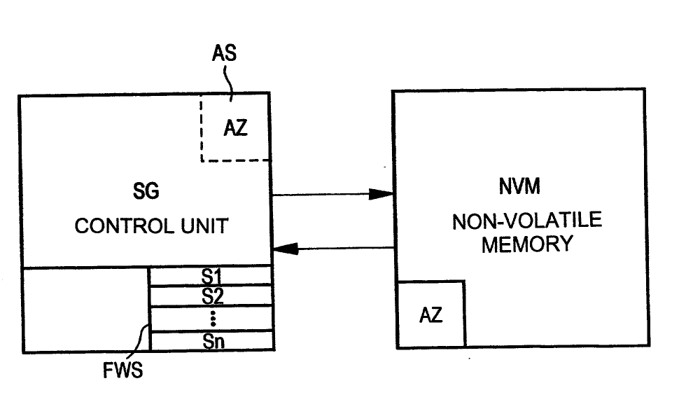

### BACKGROUND OF THE INVENTION

Field of the Invention:

The invention relates to a device having a control unit, which has memory devices, and a nonvolatile memory, in particular an EEPROM, connected to the control unit for data exchange purposes. Data are stored in encrypted form in the nonvolatile memory and the key or keys for encrypting the data are stored in one of the memory devices.

Such a configuration is disclosed in European patent EP 0 147 337 B1. There, however, mention is made only of a key for encrypting data which is recorded in a memory zone that is inaccessible from outside the portable carrier in that document. No indication is given as to how the key can be accessed.

A device of the abovementioned type is also disclosed, in principle, in the commonly assigned U.S. Pat. No. 6,182,217 (International PCT publication WO 98/39701). In a departure from the application in a smart card as proposed in that case, this device can also be used in a motor vehicle, in particular in an immobilizer, a central locking system, or a remote control of the motor vehicle.

The combination of a controller with a nonvolatile memory is typically used when data are regularly used but are nevertheless intended to be individual. Data which undergo changes during operation of the device but are then not to be lost are also usually stored in nonvolatile memories.

Data of a confidential nature that is thus worth protecting are often stored in the nonvolatile memory. However, they are thus subject to the temptation of being found out or manipulated. For this reason, they are stored in encrypted form, so that the data are of no use to anybody gaining access to the nonvolatile memory.

In the prior art device, the key or keys is or are likewise stored in the nonvolatile memory. This does not constitute a problem in that case because the keys therein cannot leave the entire device since the nonvolatile memory therein is under the control of the control unit.

### SUMMARY OF THE INVENTION

It is accordingly an object of the invention to provide a configuration with a control unit and a non-volatile memory, which overcomes the above-mentioned disadvantages of the heretofore-known devices and methods of this general type and wherein the key is secure against access from outside even though access to the nonvolatile memory is possible.

With the foregoing and other objects in view there is provided, in accordance with the invention, a device, comprising:

a control unit having memory devices;

a nonvolatile memory, such as an EEPROM, connected to the control unit for data exchange; and

the nonvolatile memory storing data in encrypted form and one of the memory devices of the control unit storing one or more keys for encrypting the data;

wherein an address pointer indicating an address of a respectively valid key in the memory device in one of the nonvolatile memory and a volatile memory of the control unit.

In other words, the device according to the invention stores the key or keys for encrypting the data held in the nonvolatile memory in a memory device. In a development of the invention, such a memory means may be a nonvolatile memory, in particular the program memory of the control unit, or a volatile memory, in particular the main memory of the control unit. In this case, the nonvolatile memory may be designed as a mask-programmed ROM or else in programmable form, for example as flash EEPROM. These memory means are under the constant control of the control unit, so that they cannot be read impermissibly. The key is therefore securely protected.

In order that an individual key can be selected, an address pointer which specifies the address at which the valid key is stored in the memory means is stored in the nonvolatile memory. As an alternative, the address pointer may also be stored in a volatile memory, for example the main memory of the control unit.

In order that, in different devices, each nonvolatile memory can be provided with individually encrypted data, in a development of the invention a plurality of keys which are all stored in the memory means are advantageously provided.

The address pointer is advantageously formed with control-unit-dependent and/or with control-unit-external parameters. These may be, for example, the serial number of the control unit of the device or of a further control unit. It may be any bit combination that is present in the entire system and can be accessed. In the same way, such a bit combination or a plurality of such bit combinations can serve as input data for the key generating algorithm.

In order to be able to save memory space in the read-only memory, in a particularly advantageous manner the keys can be formed from parts of the data stored therein, in particular of the program code, which represents quasi random numbers. By this means, it is then possible to realize a large number of keys in order, e.g. in the case of an application of the device in motor vehicles, to give each motor vehicle an individual key.

Other features which are considered as characteristic for the invention are set forth in the appended claims.

Although the invention is illustrated and described herein as embodied in a device having a control unit and a nonvolatile memory, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single FIGURE is a block diagram of a configuration according to the invention.

### DESCRIPTION OF THE PREFERRED EMBODIMENTS

Referring now to the sole FIGURE of the drawing in detail, a control unit SG, which is formed in particular with a microprocessor, has a read-only memory FWS, which is advantageously formed by the program memory of the control unit SG. In the spirit of the invention, however, it is equally possible to use any arbitrary read-only memory which is under the control of the control unit SG. All that is important is that it cannot be read externally without authorization.

A number of keys S1 . . . Sn are stored in the read-only memory FWS, with which keys the control unit SG can encrypt data that are intended to be stored in a nonvolatile memory NVM, or can decrypt data which have been read from the nonvolatile memory NVM. The nonvolatile memory NVM may be, in particular, an EEPROM. The latter is connected to the control unit SG via a bidirectional data and control line.

The nonvolatile memory NVM has a memory area wherein an address pointer AZ is stored. This address pointer AZ specifies the address under which the individual key Si, i=1 . . . n for the nonvolatile memory NVM is stored in the read-only memory FWS.

If data from the nonvolatile memory NVM are intended to be decrypted, the control unit SG firstly reads the address pointer AZ from the nonvolatile memory NVM and then fetches the key Si, i=1 . . . n, which is at the corresponding address in the read-only memory FWS. Afterward the data can be decrypted.

The address pointer AZ may advantageously be formed from control-unit-dependent and/or from control-unit-external parameters. For this purpose, it is possible to use, for example, the serial number of the control unit SG or of a further control unit, which is transmitted by the latter for instance during the training of the device within a system, for example a motor vehicle. As an alternative or in addition, it is also possible to use parameters of the nonvolatile memory NVM or arbitrary hardware coding to form the address pointer AZ.

In order to increase the security, in an alternative embodiment of the invention, the address pointer AZ may also be stored in a volatile memory, for instance the main memory AS—represented by broken lines—of the control unit SG. Instead of storage in a memory means FWS, AS controlled by the control unit SG, as an alternative or else in addition, the key can be generated by means of an algorithm executed in the control unit SG. This can be effected after the first start-up of the device, whereupon the key is subsequently stored in a nonvolatile memory, or else after each time the device is switched on. In this case, it suffices for the key to be stored in a volatile fashion, for example in the main memory AS. In principle, it is also possible, as already explained, to generate the key prior to each use.

What is advantageously achieved by the device according to the invention, in the case of application in a motor vehicle, is vehicle-specific encryption of a control-unit-external nonvolatile memory without the presence of a further writeable memory in the control unit.

We claim:

1. A device, comprising:
a control unit having memory devices;
a nonvolatile memory connected to said control unit for data exchange; and
said nonvolatile memory storing data in encrypted form and one of said memory devices of said control unit storing at least one key for encrypting the data;
wherein an address pointer indicating an address of a respectively valid key in the memory device is stored in one of the non volatile memory and a volatile memory of that control unit.

2. The device according to claim 1, wherein said nonvolatile memory is an EEPROM.

3. The device according to claim 1, wherein said at least one key is one of a plurality of keys.

4. The device according to claim 1, wherein said memory device storing the key is a read-only memory.

5. The device according to claim 1, wherein said memory device storing the key is a volatile memory.

6. The device according to claim 1, wherein the address pointer is formed with control-unit-dependent parameters.

7. The device according to claim 1, wherein the address pointer is formed with control-unit-dependent and control-unit-external parameters.

8. The device according to claim 1, wherein the address pointer is formed with control-unit-external parameters.

9. The device according to claim 1, wherein the at least one key is a constituent part of a program code stored in said read-only memory.
